(19) United States
(12) Patent Application Publication
(10) Pub. No.: US 2024/0396740 A1
(43) Pub. Date: Nov. 28, 2024

(54) LATTICE-BASED CRYPTOGRAPHIC DIGITAL SIGNATURE SCHEME UTILISING MASKING

(71) Applicant: PQShield Ltd, Oxford (GB)

(72) Inventors: Rafaël DEL PINO, Oxford (GB); Thomas PREST, Oxford (GB)

(21) Appl. No.: 18/793,108

(22) Filed: Aug. 2, 2024

Related U.S. Application Data
(63) Continuation of application No. PCT/EP2023/052730, filed on Feb. 3, 2023.

(30) Foreign Application Priority Data
Feb. 3, 2022 (EP) 22305122.8

(51) Int. Cl. H04L 9/32

(52) U.S. Cl. CPC H04L 9/3247; H04L 9/3218

(57) ABSTRACT

There is disclosed a computer-implemented method for generating a Fiat-Shamir digital signature in accordance with a signing key and a verification key, the signing key corresponding to a plurality of secret shares of a secret where each secret share is sampled from a modulo q base ring and the verification key corresponding to a public matrix sampled from the modulo q base ring and solution data. The larger the number of secret shares, the greater the countermeasure against side channel attacks but also the greater the processing complexity. In this regard, the computer-implemented method provides for efficient scaling between the number of secret shares and the processing complexity.

### CROSS-REFERENCE TO RELATED APPLICATIONS

This application is a continuation under 35 U.S.C. § 120 of International Application No. PCT/EP2023/052730, filed Feb. 3, 2023 which claims priority to EP Application No. EP 22305122.8, filed Feb. 3, 2022, under 35 U.S.C. § 119(a). Each of the above-referenced patent applications is incorporated by reference in its entirety.

### TECHNICAL FIELD

The present invention relates to a cryptographic digital signature scheme to verify the integrity and origin of an electronic message. The invention has relevance to a post-quantum lattice-based cryptographic digital signature scheme utilising masking as a countermeasure to side channel attacks.

### BACKGROUND

A digital signature scheme enables a signer to attach a digital signature to a message so that a verifier can verify that the message is identical to the message as signed by the signer. A digital signature scheme generally involves three operations: key generation, signing and verifying. In the key generation operation, a signing key sk and a verification key vk are generated. The signing key sk is private to the signer, while the verification key vk may be public and is known to the verifier. In the signing operation, the signer generates a digital signature for a message. In the verifying operation, the verifier verifies the message using the digital signature and the verification key vk.

The Fiat-Shamir transform (or heuristic) is a methodology that turns an identification scheme into a signature scheme via a generic transform. Signatures that are derived from this methodology are called Fiat-Shamir signatures. A three-pass identification scheme involves i) a prover making a commitment available to a verifier, ii) the verifier sending a challenge to the prover, and iii) the prover sending a response to the challenge to the verifier and the verifier processing the response to confirm that the prover knows a private key without the verifier gaining any knowledge of the private key. A corresponding digital signature scheme involves the signer generating the challenge by applying a hash function to data comprising a commitment, a verification key and the message being signed, and forms a digital signature comprising the commitment and the response. Based on the message, the digital signature and the verification key, the verifier can recreate the challenge and verify the response, thereby verifying the integrity of the message.

Lattice-based cryptographic schemes, such as those based on learning with errors (LWE) and short integer solution (SIS) problems, are of interest because lattice-based cryptographic schemes are conjectured to be resistant to attacks by attackers having access to a large-scale quantum computer. Accordingly, lattice-based cryptographic schemes are typically considered to be a subset of post-quantum cryptography.

Lattice-based cryptographic schemes may be vulnerable to side-channel attacks in which an adversary learns side-channel information about the physical execution of an algorithm. The side-channel information may be derived from many sources such as running time, electromagnetic emissions, energy consumption and acoustic emissions. Various studies have demonstrated that side-channel information about the execution of lattice-based signing algorithms may allow an adversary to recover the signing key sk that was used.

One countermeasure that has been proposed against side-channel attacks is masking, which relies upon techniques in the fields of secret sharing and multi-party computation (MPC). Given a sensitive value x∈ [symbol] _{q}, masking x consists of representing x as a tuple (x₁, . . . ,x_{d})∈ [symbol] _{q}^{d}, where d is the number of shares (also referred to as the sharing order) and in the context of masking d-1 is often called the masking order, such that (i) Σᵢ₋₁^{d}xᵢ=x mod q and (ii) any subset of t<d distinct x_{i'}s looks uniformly random. This tuple may be represented by the notation [symbol] x [symbol] _{d} or [symbol] x [symbol] when d is clear in context. The rationale of masking is that an attacker with the ability of learning the value of t<d variables xᵢ will learn nothing about x.

Increasing the value of d strengthens the countermeasure against side-channel attacks, but a challenging aspect of masking is that increasing the value of d often results in the computational complexity scaling with quadratic (or higher) overhead.

### SUMMARY

According to a first aspect of the present invention, there is provided computer-implemented method for generating a signature keypair for a Fiat-Shamir digital signature. The method comprises generating a public matrix by sampling a modulo q base ring and generating a plurality of secret shares of a secret, each secret share being generated by sampling the modulo q base ring. For each secret share, the product of the secret share and the matrix is determined to generate a modified secret share and the modified secret shares are rounded at modulo p, where p≠q, to generate a plurality of rounded secret shares, which are decoded to generate solution data. A signing key corresponding to the plurality of secret shares and a verification key corresponding to the public matrix and the solution data can then be returned. When the sampling of the secret shares from the modulo q base ring is unconstrained (i.e. uniform secret LWE), the signing key and the verification key can be provided in such a way that the processing complexity scales linearly with the number d of the plurality of secret shares. If the secret is constrained to be short (i.e. small secret LWE), the key generation time becomes quadratic in d.

According to a second aspect of the invention, there is provided a computer-implemented method for generating a Fiat-Shamir digital signature in accordance with a signing key and a verification key, in which the signing key corresponds to a plurality of secret shares of a secret where each secret share is sampled from a modulo q base ring and the verification key corresponds to a public matrix sampled from the modulo q base ring and solution data. The method comprises generating a plurality of random shares, each random share being generated by sampling a plurality of parameters from the modulo q base ring, and for each random share, determining the product of the random share and the public matrix to generate a plurality of modified random shares. Each modified random share is rounded at modulo p, where p≠q, to generate a plurality of rounded random shares, and then the plurality of rounded random shares are decoded to generate commitment data. A Hash function is then applied to data comprising the message and the commitment data to generate challenge value c, and a plurality of response shares is generated by, for each secret share, multiplying the respective secret share by the challenge value c and adding a respective random share and the plurality of response shares are decoded to generate response data. The difference between the product of the response data and the public matrix and the product of the challenge value c and the solution data is calculated to provide test data, and hint data is determined by modulo p rounding the test data to generate rounded test data and determining the difference between the response data and the rounded test vector. A digital signature comprising the response data and the hint data can then be returned. In this way, the digital signature can be provided in such a way the processing complexity scales quasilinearly with the number d of the plurality of secret shares, regardless of whether the sampling of the random shares is unconstrained or constrained to be small.

According to a third aspect of the invention, there is provided a computer-implemented method of verifying a message using an associated Fiat-Shamir digital signature, comprising response data and hint data, in accordance with a signing key and a verification key, in which the signing key corresponds to a plurality of secret shares of a secret where each secret share is sampled from a modulo q base ring and the verification key corresponds to a public matrix sampled from the modulo q base ring and solution data derived using the public matrix and the plurality of secret shares. A Hash function is applied to data comprising the message and commitment data to generate challenge value c. The difference between the product of the response data and the public matrix and the product of the challenge value c and the solution data is calculated to provide test data, and the test data is rounded at modulo p to provide rounded test data. It is then verified that the sum of the rounded test data and the hint data corresponds to the commitment data.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 schematically shows the main components of an example of an electronic messaging system employing a digital signature scheme.

FIG. 2 schematically shows the main components of a device capable of performing key generation, signing and verification operations.

### DETAILED DESCRIPTION

Examples described herein relate to electronic messaging systems in which a signer generates a digital signature for an electronic message and a verifier verifies the electronic message using the digital signature.

### System Overview

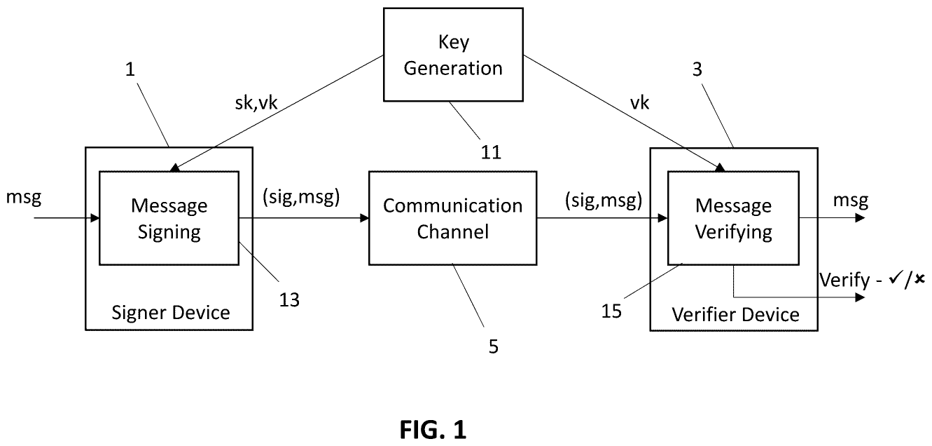

As shown in FIG. 1, an electronic messaging system includes a signer device 1 which sends a signed message (sig,msg) to a verifier device 3 vis a communication channel 5.

The signer device 1 is a processing device having a transmitter (not shown in FIG. 1) to transmit the signed message (sig,msg) into the communication channel 5. For example, the signer device 1 may be a server computer, a desktop computer, a laptop computer, a tablet device or a smartphone. While FIG. 1 shows the signer device 1 receiving an unsigned message msg, alternatively the unsigned message msg may be generated by the signer device 1.

Similarly, the verifier device 3 is a processing device having a receiver (not shown in FIG. 1) to receive a signed message (sig,msg) from the communication channel 5. For example, the verifier device 3 may be a server computer, a desktop computer, a laptop computer, a tablet device or a smartphone. While FIG. 1 shows the verifier device 3 outputting an unsigned message msg, alternatively the unsigned message msg may be processed by the verifier device 3.

The communication channel 5 may communicate electronic messages over a communication network such as a local area network (LAN), wide area network (WAN), public land mobile network (PLMN), system area network (SAN) or the like. The communication channel 5 may involve the signer device 1 storing the message msg in memory for subsequent retrieval by the verifier device 3.

The electronic messaging system of FIG. 1 has a key generation circuit 11 that generates a signature keypair comprising a signing key sk and a verification key vk. Both the signing key sk and the verification key vk are provided to the signer device 1, but only the verification key vk, not the signing key sk, is provided to the verifier device 3. Although the key generation circuit 11 is shown external to the signer device 1 in FIG. 1, it will be appreciated that the key generation circuit 11 may be provided in the signer device 1, with the signer device 1 communicating the verification key vk to the verifier device 3, for example via the communication channel 5.

The signer device 1 includes a message signing circuit 13 which receives the unsigned message msg and outputs the signed message (sig,msg).

The verifier device 3 includes a message verifying circuit 15 which receives the signed message (sig,msg) and outputs the unsigned message msg and an indication whether or not the content of the unsigned message msg has been verified.

The key generation circuit 11, the message signing circuit 13 and the message verifying circuit 15 may be embodied in hardware, software or a combination of hardware and software. For example, one or more of the key generation circuit 11, the message signing circuit 13 and the message verifying circuit 15 may comprise a cryptographic coprocessor that accelerates cryptographic operations in a System-on-Chip (SoC) environment on a Field Programmable Gate Array (FPGA) or an Application Specific Integrated Circuit (ASIC).

An example of the operations performed by the key generation circuit 11, the message signing circuit 13 and the message verifying circuit 15 will now be described in detail. In this discussion, the following notation will be used:
a vector will be represented in lowercase bold font (e.g. t);
a Matrix will be represented in uppercase bold font (e.g. A);
R_{q} is the base ring, which is commutative: it may for example be a quotient ring of the form [symbol] _{q}[x]/(xⁿ+1), where [symbol] _{q}= [symbol] /q [symbol] is the ring of integers modulo q; the notation x←S means that x is sampled uniformly at random from the set S;
given x ϵ [symbol] _{q}, └x┐ₚ=└x/p┐, which is referred to as a modulus rounding operation (by coefficient-wise application, this operation can be extended to elements of R_{q} and vectors over R_{q});

### Key Generation

The manner in which the key generation circuit 11 generates a signature keypair may be represented by the following pseudocode:

```
Require: ∅
Ensure: A signature keypair ( [symbol]   sk [symbol]   , vk), where [symbol]   sk [symbol]   is an order-d
sharing of sk
  1: A ← [symbol]   _{q}^{k×l}
  2: [symbol]   s [symbol]   ← ( [symbol]   _{q}^{l})^{d}
  3: [symbol]   t [symbol]   ← A · [symbol]   s [symbol]
  4: [symbol]   t [symbol]   ← OrderSwitch_{d→d′}( [symbol]   t [symbol]   )
  5: [symbol]   t [symbol]   ← ApproxRound( [symbol]   t [symbol]   )
  6: t := Decode( [symbol]   t [symbol]   )
  7: return ( [symbol]   sk [symbol]   := [symbol]   s [symbol]   , vk := (A, t))
```

In line 1, a k×l matrix A is sampled from the base ring R_{q}.

In line 2, d l-dimensional vectors are sampled from the base ring R_{q} to generate an order-d sharing [symbol] s [symbol] of a secret s. Since the secret s is uniform in R_{q}¹, the secret s can be generated in a masked manner securely and efficiently by sampling each share uniformly and independently.

In line 3, each of the d shares [symbol] s [symbol] of the secret s is multiplied by the matrix A to generate d shares [symbol] t [symbol] of a vector t. Contrary to conventional LWE lattice cryptography schemes, there is no sampled error term in line 3 of the pseudocode. Sampling such an error term in a masked manner would be computationally expensive. Accordingly, as will be described hereafter, an alternative approach is adopted to introducing a deliberate error into the vector t.

In line 4, a function, also called a gadget, that is referred to as OrderSwitch is applied to the vector t to transform the order-d sharing of t into an order-d′ sharing of t, where d′≥d. Pseudocode for the OrderSwitch gadget is set out below for converting d shares of a value x into d′ shares of the value x.

```
Require: An order-d sharing [symbol]   x [symbol]   _{d} of a value x, a value d′ ≥ d
Ensure: An order-d′ sharing y = [symbol]   x [symbol]   _{d′} of a value x
  1: y = (yᵢ)_{i∈[d′]} := (0)_{i∈[d′]}
  2: for i ∈ [d] do
  3: yᵢ := xᵢ
  4: y ← Refresh_{d′} (y)
  5: return y
```

It will be seen that in effect a number d′-d null vectors are added and to generate d′ shares, and then a Refresh operation is performed to generate d′ new shares for x. The Refresh operation can be performed in time O(d) (see, for example, the article entitled “Provably secure higher-order masking of AES” by Rivain and Prouff in CHES 2010, volume 6225 of LNCS, pages 413-427, Springer, Heidelberg, August 2010), but for stronger security Refresh operations in time O(dlogd) (see, for example, the article entitled “Horizontal side-channel attacks and countermeasures on the ISW masking scheme” by Battistello et al in CHES 2016, volume 9813 of LNCS, pages 23-39, Springer, Heidelberg, August 2016) may be performed instead of or in addition to Refresh operations in time O(d). By coefficient-wise application, OrderSwitch can be trivially generalised to vectors, such as the shares of t, as well as polynomials and matrices.

The purpose of the order switching in line 4 of the key generation pseudocode is to act as a countermeasure to the shares of t being probed by an adversary before an error term is introduced.

Line 5 of the key generation pseudocode effectively introduces an error term using a gadget that is referred to as ApproxRound. Pseudocode for the ApproxRound gadget for an order-d sharing value x is set out below.

Require: An order-d sharing [symbol] x [symbol] = (xᵢ)_{i∈[d]} of a value x
Ensure: An order-d sharing [symbol] y [symbol] of a value y ∈ [symbol] ₚ such that |y − └x┐ₚ | ≤
d
1: return (└xᵢ┐ₚ)_{i∈[d]}

It will be seen that each share of the value x is modulo p rounded, where p≠q, which in this example involves each co-efficient of each share of the value x being input to the function round(x/p), where round ( ) denotes a rounding operation that maps a floating point value to the nearest integer. The gadget ApproxRound has the effect that the decoded value x is only correct up to an additive term upper- and lower-bounded by ±d. By coefficient-wise application, ApproxRound can be trivially generalised to vectors, such as the shares of t, as well as polynomials and matrices.

Returning to the key generation pseudocode, at line 6 the vector t is decided from the order-d sharing following the application of the ApproxRound gadget. Finally, at line 7, the key generation pseudocode returns the order-d sharing [symbol] s [symbol] of the secret s as the secret key sk and a verification key comprising the matrix A and the vector t. As shown in FIG. 1, both the signing key sk and the verification key vk are known to the signing device 1, while only the verification key vk is known to the verifying device.

As all the operations set out above for key generation may be performed in time O(d), the key generation may occur in time O(d). However, as discussed above, in order to claim strong security guarantees, alternative Refresh gadgets may be utilised which would increase the total running time to O(dlogd).

### Sign

The manner in which the message signing circuit 13 generates a signature sig for a message msg using the signing key sk may be represented by the following pseudocode.

| Require: A masked signing key [symbol] sk [symbol] , a message msg | |
|---|---|
| Ensure: A signature sig of msg under sk | |
| 1: [symbol] r [symbol] ← ( [symbol] _{q}^{l})d | [symbol] [symbol] r [symbol] is masked ephemeral randomness |
| 2: [symbol] u [symbol] ← A · [symbol] r [symbol] | |
| 3: [symbol] u [symbol] ← OrderSwitch_{d→d′}( [symbol] u [symbol] ) | |
| 4: [symbol] w [symbol] ← ApproxRound( [symbol] u [symbol] ) | |
| 5: w ← Decode( [symbol] w [symbol] ) | [symbol] w is the commitment computed by the signer |
| 6: c := H(w, msg) | [symbol] c is the challenge |
| 7: [symbol] z [symbol] := c · [symbol] s [symbol] + [symbol] r [symbol] | |
| 8: z ← Decode( [symbol] z [symbol] ) | [symbol] z is the response |
| 9: y := A · z − c · t | |
| 10: h := w − └y┐ₚ | [symbol] h is the hint |
| 11: if (∥h∥₂ > B₂) or (∥h∥_{∞} > B_{∞}) then | |
| 12: goto Line 1 | [symbol] Lines 11 and 12 perform a soundness check |

13: return sig := (w, z, h)

In line 1, d l-dimensional vectors are randomly sampled from the base ring R_{q} to generate an order-d sharing [symbol] r [symbol] of an ephemeral randomness vector r. Since the ephemeral randomness vector r is uniform in R_{q}¹, the ephemeral randomness vector r can be generated in a masked manner securely and efficiently by sampling each share uniformly and independently.

In line 2, each of the d shares [symbol] r [symbol] of the ephemeral randomness vector r is multiplied by the matrix A to generate d shares [symbol] u [symbol] of a vector u. In line 3, the OrderSwitch gadget is applied to the vector u to transform the order-d sharing of u into an order-d′ sharing of u, where d′≥d.

In line 4, the ApproxRound gadget is applied to the order-d′ sharing of u to generate an order d′ sharing of a vector w. The vector w is then decoded from the order-d′ sharing in line 5, the vector w being the commitment computed by the signing device.

In line 6, a challenge c is generated by applying a hash function to data including the commitment w and the message msg. In line 7, an order-d sharing of a vector z, which is the response, is generated by multiplying the order-d shares of the secret s by the challenge c and then adding the order-d shares of the ephemeral randomness vector r. In line 8, the response vector z is decoded from the order-d sharing computed in line 7.

In line 9, a vector y is calculated by multiplying the response vector z by the matrix A of the verification key vk and adding c times the vector t from the verification key vk.

A notable effect of the approximate rounding of the order-d′ sharing of the vector u in line 4 is that of breaking correctness because the noise introduced by that operation means that the probability that the modulo rounding └y┐ is equal to the commitment w is negligible. To address this issue, in line 10 a hint vector h is generated by subtracting └y┐ from w.

If unconstrained, the hint vector h may break the soundness of the signature generation. To address this, a soundness check is performed in which compliance with one or more shortness constraints are verified. In particular, in this example in line 11 involves checking that the Euclidian norm and the infinite norm of the hint vector h do not exceed respective bounded values B₂ and B_{∞}(although other shortness constraints could be checked). If either of the bounded values is exceeded, then at line 12 the routine reverts to line 1 and a new ephemeral randomness vector r is calculated. Otherwise, at line 13, a digital signature sig is returned comprising the commitment vector w, the response vector z and the hint vector h.

For a nominal execution of the generation of a digital signature, the infinity norm B_{∞} will always be less than or equal to d. Setting B₂ to d\sqrt{nk}, where n is the order of the polynomial of the base ring R_{q}, and B_{∞} to d allows the soundness check of lines 11 and 12 to be removed. However, by setting B₂ and B_{∞} to lower values will improve security but require the retention of the soundness check in lines 11 and 12.

The parameters used to generate the base ring [symbol] _{q}[x]/phi, where phi is a polynomial function and the integer moduli p, q may be selected to achieve a desired level of security for a selected number of users and a number of shares d. A relationship between those parameters and the desired level of security, and the selected number of users and shares d can be established using, for example, analysis similar to that discussed in the article “Can Round-Optimal Lattice-Based Blind Signatures be Practical?” by Agrawal et al, available at 1565.pdf (iacr.org).

It is notable that the signature generation requires neither rejection sampling nor a correctness check, which are common in Schnorr-type lattice-based signatures. Rejection sampling is eliminated due to the use of uniform secret LWE, while the correctness check is unnecessary due to the use of the hint h.

As with key generation, as all operations in message signing are performed in time O(d), the running time for message signing is O(d). Again, the running time can increase to O(dlogd) if Refresh gadgets are applied.

### Verify

The manner in which the message verifying circuit 15 verifies a signature sig for a message msg using the verification key vk may be represented by the following pseudocode.

```
Require: A verification key sk, a message msg, a signature sig
Ensure: accept or reject
  1: if (∥h∥₂ > B₂) or (∥h∥_{∞} > B_{∞}) or (└Az − ct┐ₚ + h ≠ w) then
  2: reject
  3: else
  4: accept
```

As shown in line 1, three checks are performed. The first and second checks are that the that the Euclidian norm and the infinite norm of the hint vector n do not exceed their respective bounded values B₂ and B_{∞}(although as discussed above in relation to checking soundness during signing, checks based on other shortness constraints could be performed). The third check involves recreating the challenge c by applying a hash function to the data comprising the commitment vector w and the received message msg in the same manner as in line 6 of the message signing pseudocode, and then checking whether the difference between the commitment vector w and the hint vector h is equal to the modulo p rounding of the vector formed by multiplying the response vector z from the digital signature sig by the matrix A of the verification key vk and then adding c times the vector t from the verification key vk. If any of the three checks fails, then verification is rejected. Otherwise, verification is accepted.

### Device

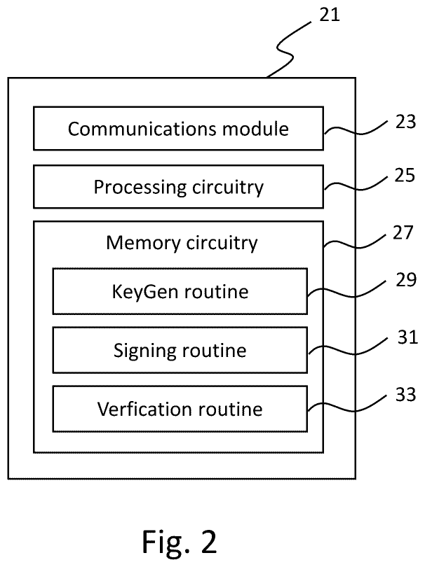

FIG. 2 shows schematically the main components of a device 21 that can be used to implement the digital signature scheme described above. The device 21 includes a communications module 23 for wired or wireless communication with other devices participating in the digital signature scheme. The communications module 23 may for example include one or more antennae for communications via a core network and a radio access network, in the case of a mobile communications device such as a smartphone.

The device 21 further includes processing circuitry 25 and memory circuitry 27. The processing circuitry 25 may include one or more processing units such as a central processing unit (CPU), specialist processing units such as a digital signal processor (DSP), a subscriber identity module (SIM), a hardware-integrated trusted execution environment (TEE), and/or one or more application-specific integrated circuits (ASICs) or application-specific standard products (ASSPs). The memory circuitry 27 may include volatile random-access memory (RAM), in particular static random-access memory (SRAM) and dynamic random-access memory (DRAM), along with non-volatile memory and storage such as flash memory, an integrated solid state drive (SSD), and integral hard disk drive (HDD), and/or one or more removable storage devices.

The memory circuitry 27 holds machine-readable instructions for implementing various functions described in the present disclosure. In particular, the memory circuitry 27 stores a KeyGen routine 29 for generating a public/private key pair as described above, a Signing routine 31 for signing a message as described above and a Verification routine 33 for verifying a digital signature to validate a message as described above.

It will be appreciated that a device for use with the described digital signature scheme need not store all of the KeyGen routine 29, the Signing routine 31 and the Verification routine 33. For example, one device may store the KeyGen routine 29 and the Signing routine 31, while another device may store only the Verification routine 33.

### Modifications

The sampling of the secret shares during key generation and the random shares during signing in the pseudocode presented above is unconstrained. In other words, the pseudocode implements uniform secret LWE. Alternatively, small secret LWE could be utilised in which:
during key generation, a representation of s can be generated bit-by-bit, followed by a Boolean-to-arithmetic conversion, which can be performed in time O(d²) when the masked value to convert is a single bit (see for example the article entitled “High-order table-based conversion algorithms and masking lattice-based encryption” by Coron et al, Cryptology ePrint Archive, Report 2021/1314); during signing, each of the random shares [symbol] r [symbol] may be sampled uniformly in {x ϵ R_{q}¹|∥x∥_{∞}≤B}, ensuring that ∥r∥_{∞}≤dB, which provides meaningful security guarantees at time O(d); and
during verification, a check may be performed that z is short.

A downside of using small secret LWE as set out above is therefore that key generation occurs at O(d²), but the signing time remains quasilinear.

While the pseudocode set out above employs modulo p rounding to the nearest integer, alternatively modulo p truncating functions (which divide co-efficients by p and rounds the resultant floating point values to their integer components) or modulo p ceiling functions (which divide co-efficients by p and round the resultant floating point values to the next-highest integer value in magnitude) could be employed to convert a floating point value to an integer value, and the phrase “rounding at modulo p” encompasses all such operations.

A person skilled in the art will appreciate that when setting the moduli p and q there is a requirement to consider constraints both on security and correctness. It is common in lattice-based cryptography that two opposite constraints exist on the modulus q: the need to avoid leaking information through the verification key favours a small q while improving security against forgeries favours large q. Accordingly, q should not be too small or too large. Similarly, p should not be too small or too large as while increasing p reduces security, reducing p increases the size of the hint.

In the pseudocode, the verifier key includes the matrix A. Alternatively, the matrix A could be generated from a short publicly known seed value and a pseudo-random function, in which case the seed value is usually easier to store and send than the matrix A.

While the digital signature in the system described above includes the commitment, it will be appreciated that the commitment could be replaced by the challenge. In such a case, the third check of the message verifying involves confirming that H(└Az−ct┐+h, msg)=c.

It will be appreciated that, in an analogous fashion to a five pass, or more generally 2n+1 pass where n is an integer, identification scheme, more than one set of challenge data may be utilised.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A computer-implemented method for generating a Fiat-Shamir digital signature in accordance with a signing key and a verification key, the signing key corresponding to a plurality of secret shares of a secret where each secret share is sampled from a modulo q base ring and the verification key corresponding to a public matrix sampled from the modulo q base ring and solution data, the method comprising:
generating a plurality of random shares, each random share being generated by sampling a plurality of parameters from the modulo q base ring;
for each random share, determining the product of the random share and the public matrix to generate a plurality of modified random shares;
rounding each of the modified random shares at modulo p, where p≠q, to generate a plurality of rounded random shares, and decoding the plurality of rounded random shares to generate commitment data;
applying a Hash function to data comprising the message and the commitment data to generate challenge value c;
generating a plurality of response shares, the generation of each response share comprising multiplying a respective secret share by the challenge value c and adding a respective random share;
decoding the plurality of response shares to generate response data;
determining test data by determining the difference between the product of the response data and the public matrix and the product of the challenge value c and the solution data;
determining hint data by modulo p rounding the test data to generate rounded test data and determining the difference between the response data and the rounded test vector; and
returning a digital signature comprising the response data and the hint data.

2. The computer-implemented method of claim 1, wherein the random sampling is uniform.

3. The computer-implemented method of claim 1, wherein rounding each of the modified random shares at modulo p comprises dividing co-efficient values of the modified random shares by p and rounding to the nearest integer value.

4. The computer implemented method of claim 1, further comprising checking one or more shortness constraints for the hint data.

5. The computer implemented method of claim 4, wherein checking one or more shortness constraints for the hint data comprises checking that the Euclidean norm does not exceed a bounded value and/or the infinite norm does not exceed a bounded value.

6. The computer-implemented method of claim 1, further comprising switching the order of the plurality of modified random shares before rounding each of the modified random shares at modulo p.

7. The computer-implemented method of claim 1, further comprising refreshing at least one of i) the plurality of random shares, ii) the plurality of modified random shares, iii) the plurality of rounded random shares and iv) the plurality of response shares.

8. The computer-implemented method of claim 1, wherein the verification key comprises a seed value enabling generation of the public matrix, and/or wherein the solution data, the random shares and the test data comprise vectors, and/or wherein the digital signature comprises the commitment data.

9. A data processing apparatus comprising processing circuitry and memory circuitry, the memory circuitry storing instructions that are executable by the processing circuitry to generating a Fiat-Shamir digital signature in accordance with a signing key and a verification key, the signing key corresponding to a plurality of secret shares of a secret where each secret share is sampled from a modulo q base ring and the verification key corresponding to a public matrix sampled from the modulo q base ring and solution data, the instructions being executable to:
generate a plurality of random shares, each random share being generated by sampling a plurality of parameters from the modulo q base ring;
for each random share, determine the product of the random share and the public matrix to generate a plurality of modified random shares;
round each of the modified random shares at modulo p, where p≠q, to generate a plurality of rounded random shares, and decoding the plurality of rounded random shares to generate commitment data;
apply a Hash function to data comprising the message and the commitment data to generate challenge value c;
generate a plurality of response shares, the generation of each response share comprising multiplying a respective secret share by the challenge value c and adding a respective random share;
decode the plurality of response shares to generate response data;
determine test data by determining the difference between the product of the response data and the public matrix and the product of the challenge value c and the solution data;
determine hint data by modulo p rounding the test data to generate rounded test data and determining the difference between the response data and the rounded test vector; and
return a digital signature comprising the response data and the hint data.

10. The data processing apparatus of claim 9, wherein the random sampling is uniform.

11. The data processing apparatus of claim 9, wherein the instructions are executable to round each of the modified random shares at modulo p by dividing co-efficient values of the modified random shares by p and rounding to the nearest integer value.

12. The data processing apparatus of claim 9, wherein the instructions are further executable to switch the order of the plurality of modified random shares before rounding each of the modified random shares at modulo p.

13. The data processing apparatus of claim 9, wherein the instructions are further executable to refresh at least one of i) the plurality of random shares, ii) the plurality of modified random shares, iii) the plurality of rounded random shares and iv) the plurality of response shares.

14. The data processing apparatus of claim 9, wherein the verification key comprises a seed value enabling generation of the public matrix, and/or wherein the solution data, the random shares and the test data comprise vectors, and/or wherein the digital signature comprises the commitment data.

15. A computer-readable storage device storing instructions which, when executed by a computer, cause the computer to generate a Fiat-Shamir digital signature in accordance with a signing key and a verification key, the signing key corresponding to a plurality of secret shares of a secret where each secret share is sampled from a modulo q base ring and the verification key corresponding to a public matrix sampled from the modulo q base ring and solution data, the instructions being executable to:
generate a plurality of random shares, each random share being generated by sampling a plurality of parameters from the modulo q base ring;
for each random share, determine the product of the random share and the public matrix to generate a plurality of modified random shares;
round each of the modified random shares at modulo p, where p≠q, to generate a plurality of rounded random shares, and decoding the plurality of rounded random shares to generate commitment data;
apply a Hash function to data comprising the message and the commitment data to generate challenge value c;
generate a plurality of response shares, the generation of each response share comprising multiplying a respective secret share by the challenge value c and adding a respective random share;
decode the plurality of response shares to generate response data;
determine test data by determining the difference between the product of the response data and the public matrix and the product of the challenge value c and the solution data;
determine hint data by modulo p rounding the test data to generate rounded test data and determining the difference between the response data and the rounded test vector; and
return a digital signature comprising the response data and the hint data.

16. The computer-readable storage device of claim 15, wherein the random sampling is uniform.

17. The computer-readable storage device of claim 15, wherein rounding each of the modified random shares at modulo p comprises dividing co-efficient values of the modified random shares by p and rounding to the nearest integer value.

18. The computer-readable storage device of claim 15, further storing instructions which, when executed by the computer, switch the order of the plurality of modified random shares before rounding each of the modified random shares at modulo p.

19. The computer-readable storage device of claim 15, further storing instructions which, when executed by the computer, refresh at least one of i) the plurality of random shares, ii) the plurality of modified random shares, iii) the plurality of rounded random shares and iv) the plurality of response shares.

20. The computer-readable storage device of claim 15, wherein the verification key comprises a seed value enabling generation of the public matrix, and/or wherein the solution data, the random shares and the test data comprise vectors, and/or wherein the digital signature comprises the commitment data.
